(19) United States
(12) Patent Application Publication
(10) Pub. No.: US 2026/0159413 A1
(43) Pub. Date: Jun. 11, 2026

(54) SYSTEM AND METHOD FOR PRODUCING ACID DEFICIENT URANYL NITRATE SOLUTION WITH AN ANION EXCHANGE MEMBRANE

(71) Applicant: X-ENERGY, LLC, Rockville, MD (US)

(72) Inventor: Alex Tilton, Knoxville, TN (US)

(21) Appl. No.: 18/969,755

(22) Filed: Dec. 5, 2024

(51) Int. Cl. C01G 43/00

(52) U.S. Cl. CPC C01G 43/003

(57) ABSTRACT

A system and method for producing acid-deficient uranyl nitrate by ion exchange. The system includes an ion exchange membrane vessel having a first chamber, a second chamber, and an ion exchange membrane therebetween. The first chamber of the ion exchange membrane vessel receives a concentrated solution of uranyl nitrate; the second chamber of the ion exchange membrane vessel receives an aqueous feed solution with a low concentration of NO3 anions; and the ion exchange membrane allows diffusion of NO₃ anions from the first chamber to the second chamber, but does not allow diffusion of UO₂ cations therethrough. A vacuum distillation system receives a retentate solution from the first chamber of the ion exchange membrane vessel and produces a concentrated solution of acid-deficient uranyl nitrate.

### TECHNICAL FIELD

Various embodiments disclosed herein relate generally to:
systems for producing acid deficient uranyl nitrate from a dilute uranyl nitrate solution; and
processes for producing acid deficient uranyl nitrate from a dilute uranyl nitrate solution. Various embodiments disclosed herein relate to production of uranyl nitrate solutions suitable for use in production of nuclear fuel kernels.

### BACKGROUND

Acid deficient uranyl nitrate solutions are used in the solution gelation process for fuel fabrication. Acid deficient uranyl nitrate solutions typically have a uranium concentration between 2.80 M and 3.27 M, a nitrate concentration of 4.5 M to 5.25 M, a density of 1.85 g/cc to 2.00 g/cc, and a NO₃/U molar ratio of 1.50 to 1.75.

Dilute uranyl nitrate solutions are produced as a result of solvent extraction from spent fuel reprocessing, from uranium recovery, or from off-specification fuel solutions. Dilute uranyl nitrate solutions may have a uranium concentration from <1 g/cc and any nitrate concentration.

The typical process for producing acid deficient uranyl nitrate solutions from dilute uranyl nitrate solutions is to use direct denitration. This process produces a solid powder that must be redissolved to produce acid deficient uranyl nitrate solution and an NOx effluent that must be scrubbed from the gaseous exhaust.

In view of the foregoing, it would be desirable to have a process that allows for production of acid deficient uranyl nitrate from a dilute uranyl nitrate solution.

### SUMMARY

In light of the present need for improved methods of producing acid deficient uranyl nitrate solutions, a brief summary of embodiments disclosed herein is presented. Some simplifications and omissions may be made in the following summary, which is intended to highlight and introduce some aspects of the various embodiments, but not to limit the scope of the invention. Detailed descriptions of a preferred embodiment adequate to allow those of ordinary skill in the art to make and use the inventive concepts will follow in later sections.

Various embodiments disclosed herein relate to a method of producing acid-deficient uranyl nitrate using an ion exchange membrane vessel having a first chamber, a second chamber, and an ion exchange membrane therebetween. The ion exchange membrane allows diffusion of NO₃ anions therethrough, but does not allow diffusion of UO₂ cations therethrough. The method includes a step of feeding a concentrated solution of uranyl nitrate to the first chamber of the ion exchange membrane vessel, wherein the concentrated solution includes NO₃ anions and UO₂ cations in a ratio of at least 1.85:1. The ratio of NO₃ anions to UO₂ cations may be 1.85:1 to 2.5:1, 1.9:1 to 2.25:1, 1.95:1 to 2.1:1, or about 2:1. An aqueous feed solution with a low concentration of NO₃ anions is fed to the second chamber of the ion exchange membrane vessel. NO₃ anions diffuse through the ion exchange membrane from the first chamber of the ion exchange membrane vessel to the second chamber. A retentate solution of uranyl nitrate is withdrawn from the first chamber of the ion exchange membrane vessel, wherein the retentate solution includes NO₃ anions and UO₂ cations in a ratio of 1:1 to 1.8:1, 1:25 to 1.8:1, 1:4 to 1.75:1, 1:55 to 1.75:1, 1:5 to 1.7:1, or 1:65 to 1.7:1. A permeate solution is withdrawn from the second chamber of the ion exchange membrane vessel, where the permeate solution includes an increased concentration of NO₃ anions, relative to the aqueous feed solution. The retentate solution may include NO₃ anions and UO₂ cations in a ratio of 1.5:1 to 1.75:1, a uranium concentration of 2.80 M to 3.27 M, a nitrate concentration of 4.5 M to 5.25 M, and a density of 1.85 g/cc to 2.00 g/cc. The retentate solution of uranyl nitrate may be fed to a vacuum distillation system to produce a concentrated solution of acid-deficient uranyl nitrate.

In various embodiments, the ion exchange membrane is an anion exchange membrane. The ion exchange membrane may be an anion exchange membrane with a positively charged polyelectrolyte. The ion exchange membrane may be a polystyrene polymer or copolymer with quaternized aminostyrene repeat units; or a (meth)acrylic polymer or copolymer with quaternized aminoalkyl (meth)acrylate repeat units.

In various embodiments, the method further includes a step of feeding the concentrated solution of uranyl nitrate to a concentrate reservoir, and the step of feeding the concentrated solution of uranyl nitrate to the first chamber includes feeding the concentrated solution of uranyl nitrate from the concentrate reservoir to the first chamber.

In various embodiments, the concentrated solution of uranyl nitrate is fed to the first chamber of the ion exchange membrane vessel in a first direction; and the aqueous feed solution is fed to the second chamber of the ion exchange membrane vessel in a second direction which is countercurrent to the first direction.

In various embodiments, the ion exchange membrane vessel includes a first ion exchange membrane vessel, a second ion exchange membrane vessel, and optionally at least one third ion exchange membrane vessel. The concentrated solution of uranyl nitrate is sequentially fed to a first chamber of the first ion exchange membrane vessel, a first chamber of the optional at least one third ion exchange membrane vessel, and a first chamber of the second ion exchange membrane vessel. The aqueous feed solution flows sequentially to a second chamber of the first ion exchange membrane vessel, a second chamber of the optional at least one third ion exchange membrane vessel, and a second chamber of the second ion exchange membrane vessel.

In various embodiments, the ion exchange membrane vessel includes a first ion exchange membrane vessel and a second ion exchange membrane vessel. The concentrated solution of uranyl nitrate is fed to a first chamber of the first ion exchange membrane vessel and a first chamber of the second ion exchange membrane vessel in parallel. The aqueous feed solution is fed to a second chamber of the first ion exchange membrane vessel and a second chamber of the second ion exchange membrane vessel in parallel.

The method may further include a step of feeding a dilute solution of uranyl nitrate to an evaporator and evaporating water from the dilute solution of uranyl nitrate to produce the concentrated uranyl nitrate solution and a vapor containing water with only trace amounts of nitric acid and uranyl nitrate.

The method may further include a step of feeding the concentrated uranyl nitrate solution to a concentrate reservoir, and feeding the concentrated uranyl nitrate solution from the concentrate reservoir to the first chamber of the ion exchange membrane vessel.

The method may further include steps of:
feeding a dilute solution of uranyl nitrate to an evaporator and evaporating water from the dilute solution of uranyl nitrate to produce the concentrated uranyl nitrate solution and a vapor containing water with only trace amounts of nitric acid and uranyl nitrate; and
feeding the concentrated uranyl nitrate solution from the evaporator to a concentrate reservoir, and feeding the concentrated uranyl nitrate solution from the concentrate reservoir to the first chamber of the ion exchange membrane vessel.

The method may further include a step of condensing the vapor from the evaporator to produce an aqueous condensate, and feeding the aqueous condensate to the second chamber of the ion exchange membrane vessel as the aqueous feed solution.

Various embodiments disclosed herein relate to a system for producing acid-deficient uranyl nitrate, including:
an ion exchange membrane vessel having a first chamber, a second chamber, and an ion exchange membrane therebetween, wherein:
the first chamber of the ion exchange membrane vessel is configured to receive a concentrated solution of uranyl nitrate;
the second chamber of the ion exchange membrane vessel l is configured to receive an aqueous feed solution with a low concentration of NO₃ anions; and
the ion exchange membrane is configured to allow diffusion of NO₃ anions therethrough, but does not allow diffusion of UO₂ cations therethrough; and
a first vacuum distillation system configured to receive a retentate solution from the first chamber of the ion exchange membrane vessel and produce a concentrated solution of acid-deficient uranyl nitrate.

In various embodiments of the system, the ion exchange membrane comprises a polystyrene polymer or copolymer with quaternized aminostyrene repeat units; or a (meth)acrylic polymer or copolymer with quaternized aminoalkyl (meth)acrylate repeat units.

Various embodiments of the system further include a concentrate reservoir, wherein the concentrate reservoir is configured to store the concentrated solution of uranyl nitrate; and a first system configured to feed the concentrated solution of uranyl nitrate from the concentrate reservoir to the first chamber of the ion exchange membrane vessel.

Various embodiments of the system further include a second distillation system configured to receive a dilute uranyl nitrate solution and produce the concentrated solution of uranyl nitrate; and a second system configured to feed the concentrated solution of uranyl nitrate to the concentrate reservoir.

### BRIEF DESCRIPTION OF THE DRAWINGS

In order to better understand various exemplary embodiments, reference is made to the accompanying drawings, wherein:

FIG. 1 illustrates a summary of a process for producing acid deficient uranyl nitrate from a dilute uranyl nitrate solution;

FIG. 2 illustrates a system for concentrating a dilute uranyl nitrate solution;

FIG. 3A illustrates a system for producing an acid deficient uranyl nitrate solution by anion exchange using ion exchange membrane vessels 20A, 20B, and 20C;

FIG. 3B illustrates ion exchange membrane vessel 20A of FIG. 3A;

FIG. 3C illustrates multiple ion exchange membrane vessels connected in series;

FIG. 4 illustrates a system for concentrating an acid deficient uranyl nitrate solution with a vacuum distillation system; and

FIG. 5 illustrates a system for treating a permeate stream from the system of FIG. 3A with a vacuum distillation system.

### DETAILED DESCRIPTION

Referring now to the drawings, in which like numerals refer to like components or steps, there are disclosed broad aspects of various exemplary embodiments.

The present disclosure is directed to a system for producing acid deficient uranyl nitrate from a dilute uranyl nitrate solution. The solution may be the product of a solvent extraction process used to recycle spent nuclear fuel or a recovery stream from other fuel fabrication activities.

All vessels in this system are ≤5.56″ in outer diameter to maintain criticality control.

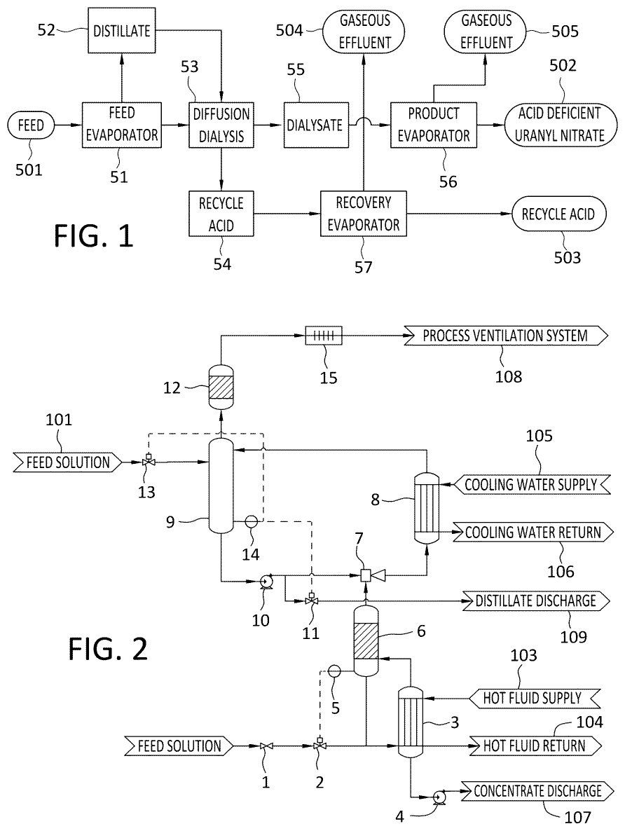

FIG. 1 shows a summary of the process disclosed herein. A dilute feed solution 501 contains a uranyl nitrate dissolved therein, where the feed solution contains nitrate anions and UO2⁺² cations in a ratio of at least 1.85:1, or about 2:1. Feed solution 501 is fed to a boiler 51, where water in feed solution 51 is distilled to produce distillate 52 and a more concentrated solution of uranyl nitrate. The solution of uranyl nitrate and distillate 52 are fed to an ion exchange system 53. The solution of uranyl nitrate and distillate 52 flow over opposite side of an ion exchange membrane in system 53, where the ion exchange membrane allows nitrate anions to flow from the solution of uranyl nitrate into distillate 52, decreasing the ratio of nitrate anions and UO₂⁺² cations to 1.8:1 or below, producing an acid-deficient uranyl nitrate (ADUN) solution as a retentate 55. Distillate 52, with an increased nitrate concentration, exits system 53 as a recycle acid stream 54.

Retentate 55 is fed to a vacuum distillation system 56, where a portion of the water in retentate 55 is distilled off and released to the atmosphere as gaseous effluent 505. A concentrated liquid acid-deficient uranyl nitrate (ADUN) solution 502 is recovered from the bottoms of vacuum distillation system 56.

Recycle acid stream 54 is fed to a vacuum distillation system 57, where a portion of the water in stream 54 is distilled off and released to the atmosphere as gaseous effluent 504. An aqueous recycle acid stream is recovered from the bottoms of vacuum distillation system 57.

In various embodiments, the acid-deficient uranyl nitrate (ADUN) solution 502 may be used in preparation of uranium oxide gel particles, which may then be sintered to produce oxide particles suitable for use an nuclear fuel kernels. Uranium oxide gel particles may be prepared by adding hexamethylene tetramine to the ADUN solution; causing the hexamethylene tetramine/ADUN solution to flow through a first nozzle and exit the first nozzle as a first stream; and causing a high-temperature nonaqueous drive fluid to flow through a second nozzle as a second stream, where the second stream contacts the first stream. Shear between the first stream and the second stream breaks the first stream into droplets of the ADUN solution, and thermal decomposition of hexamethylene tetramine by the high-temperature drive fluid converts ADUN solution droplets into uranium oxide gel particles. Such a process is described in U.S. Pat. No. 10,962,461, incorporated herein by reference.

Referring to FIG. 2, the system for producing acid deficient uranyl nitrate includes an inlet for a first feed solution 102 which flows from an origin vessel (not shown). Feed solution 102 is a dilute uranyl nitrate solution, and flows through a check valve 1 that prevents feed solution 102 from backflowing and returning to the origin vessel. An actuated valve 2 is controlled by a level sensor 5. Feed solution 102 includes NO₃ anions and UO₂ cations in a ratio of at least 1.85:1, or about 2:1. Level sensor 5 is configured to send a signal to a processor (not shown). Upon receipt of the signal from the processor, the processor closes valve 5 fully or partially. Sensor 5 is connected to a packed column 6.

Feed solution 1 flows into a boiler 3 from valve 2. Boiler 3 may be a shell and tube heat exchanger or a column with an immersion heater. In the case where the boiler is a shell and tube heat exchanger, the boiler contains a bundle of tubes running through a hollow shell. In some embodiments, the dilute uranyl nitrate feed solution 102 flows through the hollow shell in boiler 3 around the tubes, and a hot fluid 103 fluid flows into the tubes. In various embodiments, hot fluid 103 may be pressurized water, steam, or hot oil, at a temperature sufficient to boil the feed solution 102. As hot fluid 103 flows through the tubes, it flows through the hollow shell containing feed solution 102 in a counter current fashion, transferring heat from hot fluid 103 to the feed solution 102 and boiling the feed solution. The heat transfer medium may be steam or hot oil that is at a temperature hot enough to induce boiling in the feed solution 102. As feed solution 102 is heated and boiled, hot fluid 103 is cooled and leaves the tubes in the boiler 3 as a cooled heat exchange fluid 104.

In case boiler 3 is a column with an immersion heater, feed solution 102 fills the column until the immersion heater is submerged. The level of the solution is controlled so that the heating elements in boiler 3 are submerged. The heating elements heat feed solution 102 to a temperature hot enough to induce boiling in feed solution 102.

As feed solution 102 boils, the water in feed solution 102 is converted to a vapor. The vapor rises out of boiler 3 and into a packed column 6, where the vapor condenses under reflux. The condensed vapor flows to the bottom of the packed column as a distillate. Vapor may be drawn off from column 6 with venturi 7 and withdrawn as a distillate discharge 109. The packed column 6 is filled with a packing material such as Raschig rings or wire mesh that allows for more vapor/liquid contact and improves separation efficiency. When level of condensed vapor in the packed column 6 reaches the level of the sensor 5, sensor 5 sends the signal to the processor. Upon receipt of the signal from the processor, the processor may close valve 5, preventing further feed solution 102 from entering boiler 3 until an adequate amount of vapor is drawn off as distillate discharge 109.

The feed solution 102 in boiler 3 is circulated within the boiler. Solution 102 may be circulated by a thermosiphon effect, or by an attached force-circulation pump that draws feed solution 102 from the bottom of boiler 3 and discharges feed solution 102 at the top of boiler 3. As vapor is withdrawn through distillate discharge 109, feed solution 102 becomes an increasingly concentrated uranyl nitrate solution. The uranyl nitrate concentrate is allowed to dwell in the boiler 3 until a desired concentration is achieved, at which point the uranyl nitrate concentrate is withdrawn from the bottom of the boiler 3 via concentrate transfer pump 4 as concentrate discharge 107.

The system may be operated in batch mode or in a continuous mode. In a batch mode, once the level of condensed vapor in column 6 becomes high enough to cause closure of valve 5, no further feed solution 102 enters boiler 3 until uranyl nitrate concentrate is allowed to dwell in the boiler 3 until a uranyl nitrate concentrate of a desired concentration is withdrawn from the bottom of the boiler 3.

In a continuous mode, once the level of condensed vapor in column 6 becomes high enough to signal the processor, the processor may partially close valve 5, reducing the rate at which feed solution 102 enters boiler 3. Meanwhile, uranyl nitrate concentrate is withdrawn from the bottom of the boiler 3 as concentrate discharge 107 and vapor is withdrawn from column 6 as distillate discharge 109. The volume of concentrate discharge 107 exiting the boiler 3 should equal the volume of feed solution 102 entering the boiler 3. Thus, a small flow of solution is entering and exiting boiler 3 at all times such that the volume of uranyl nitrate solution in boiler 3 remains constant.

Separated vapor, which is water with only trace amounts of nitric acid and uranyl nitrate, is sucked out of the packed column 6 by a venturi 7. The venturi forms the first part of the vapor scrubbing portion of the system.

The scrubber consists of a scrubber reservoir 9 that is initially charged with fresh deionized water 101 through actuated valve 13. The scrubber solution is pumped from reservoir 9 via pump 10 through a shell of shell and tube heat exchanger 8 and back into the scrubber reservoir 9. Vapor sucked out of the packed column 6 by venturi 7 may be combined with the circulating water from reservoir 9. A level switch 14 controls the level in the scrubber reservoir 9. If the level gets too low, valve 13 is opened to fill scrubber reservoir 9. When the level in the scrubber reservoir 9 is too high, actuated valve 11 is opened and the needed amount of water is discharged through valve 11 and combined with the distillate discharge 109. The scrubber shell and tube heat exchanger 8 is connected to cooling water. Cooling water supply 105 flows through the tubes of heat exchanger 8, and exits as heated cooling water 106.

Vapor from column 6 is condensed after combining with the circulating water from scrubber 9 at venturi 7, and then passing through heat exchanger 8. If any vapor is not condensed by the time the circulating water returns to reservoir 9, the remaining vapor passes from the top of column 9 to a mist eliminator 12 that catches any liquid droplets that may have formed. The vapor then passes through a duct heater 13 that ensures the vapor remains hot enough to not condense in the ventilation system. Finally, the heated vapor is discharged to process ventilation system 108, where it can enter the atmosphere as clean water vapor.

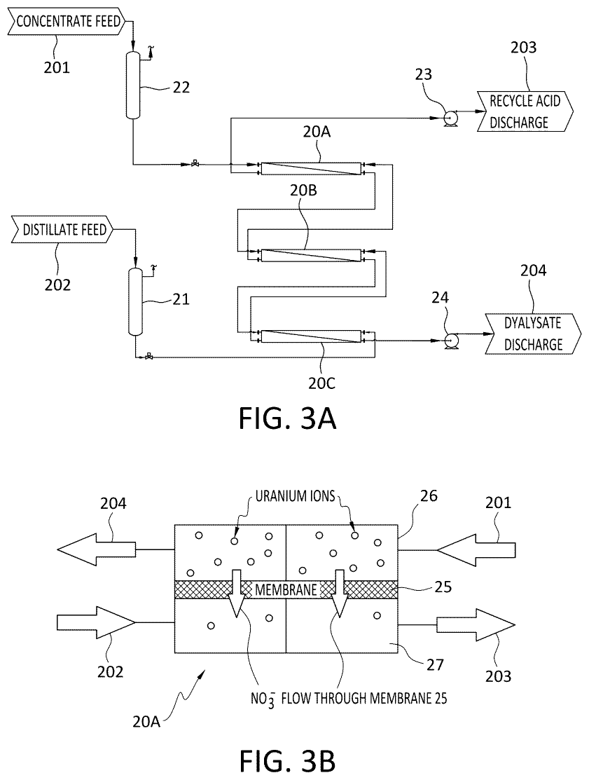

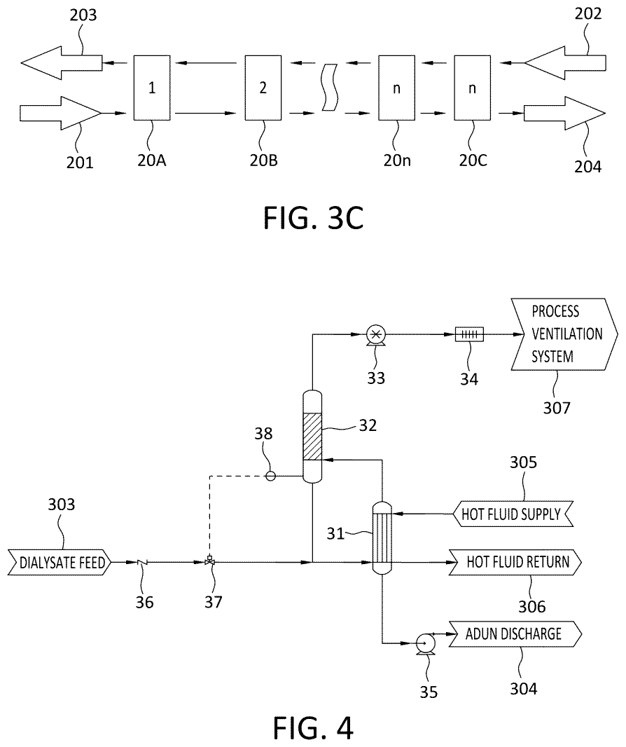

Referring to FIGS. 3A and 3B, concentrated uranyl nitrate solution is fed from concentrate discharge 107 in FIG. 2 as a concentrate feed 201 to a concentrate reservoir 22. The distillate from distillate discharge 109 is condensed and fed to the distillate reservoir 21. Pumps 28 and 29 at the discharge of reservoirs 22 and 21, respectively, control the flow of the concentrate and distillate to a membrane vessel 20A. The membrane vessel 20A contains an anion exchange membrane 25 (shown in FIG. 3B). The membrane 25 divides membrane vessel 20A into a retentate chamber 26, and a permeate chamber 27. Referring to FIG. 3B, the concentrate flows from the concentrate reservoir 22 through the retentate chamber 26, while the distillate flows from the distillate reservoir 21 through the permeate chamber 27. The distillate and the concentrate flow along the anion exchange membrane 25 in a countercurrent fashion. As the concentrate flows through retentate chamber 26, uranyl cations are retained in the retentate chamber, while nitrate anions flow through the anion exchange membrane 25 into permeate chamber 27. A uranyl nitrate solution with a reduced nitrate concentration, i.e., an acid-deficient uranyl nitrate solution, exits retentate chamber 26 as retentate 204. The retentate solution 204 included NO₃ anions and UO₂ cations in a ratio of 1:1 to 1.8:1, 1.25:1 to 1.8:1, 1.4:1 to 1.8:1, 1.5:1 to 1.75:1, or 1.6:1 to 1.7:1. A water solution with an increased nitrate concentration exits permeate chamber 27 as permeate 203.

In some embodiments, a single membrane vessel 20A may be used. In other embodiments, two, three, four, or more membrane chambers may be connected in series. FIG. 3A shows an embodiment in which three membrane vessels 20A, 20B, and 20C are connected in series, with the distillate and the concentrate flowing sequentially through each membrane vessel. The concentrate flows sequentially through the retentate chambers 26 of membrane vessels 20A, 20B, and 20C. The distillate flows sequentially through the permeate chambers 27 of membrane vessels 20C, 20B, and 20A, in a countercurrent direction to the flow of the concentrate.

The membrane vessel 20A may contain a spiral-wound anion exchange membrane or multiple tubular anion exchange membranes. The anion exchange membrane 25 separates the vessel 20A into retentate and permeate channels 26 and 27.

The anion exchange membranes may be polymeric anion exchange membranes. In some embodiments, the anion exchange membranes are polystyrene copolymer membranes containing styrene, optionally divinyl benzene, and quaternized aminostyrene monomers. The anion exchange membranes may be acrylic copolymer membranes containing alkyl (meth)acrylate monomers and quaternized aminoalkyl (meth)acrylate monomers. The anion exchange membranes may have cationic monomers with a chloride counterion. Useful membranes include poly(acrylamido-N-propyltrimethylammonium chloride) and copolymers of styrene, divinylbenzene, and quaternized 4-aminostyrene.

FIG. 3B details the process at the membrane interface. Nitrate ions in concentrate feed 201 flowing through chamber 26 are attracted to the negatively charged membrane 25 and diffuse through the membrane 25 into the distillate feed 202 in chamber 27 via diffusion. A majority of the uranyl ions in feed 201 are retained in the feed stream in chamber 26. A retentate stream 204 containing a reduced ratio of nitrate ions to uranyl ions exits chamber 26. A permeate stream 208 containing an increased concentration of nitrate ions exits chamber 27.

FIG. 3C details a process using multiple membrane vessels in series to convert concentrate feed 201, with a ratio of nitrate anions to uranyl cations of at least 1.85:1, or about 2:1, into retentate stream 204 with a target ratio of nitrate anions to uranyl cations of <1.8:1, preferably <1.7:1. The system of FIG. 3C includes at least a first membrane vessel 20A and a final membrane vessel 20C. Each of membrane vessel 20A and membrane vessel 20C includes an anion exchange membrane 25 separating a retentate chamber 26 from a permeate chamber 27, substantially as shown in FIG. 3B. Concentrate stream 201 flows sequentially through the retentate chamber 26 of membrane vessel 20A and through the retentate chamber 26 of membrane vessel 20C. Distillate feed 202 flows sequentially through the permeate chamber 27 of membrane vessel 20C and through the permeate chamber 27 of membrane vessel 20A, in a countercurrent direction to the concentrate feed. In each membrane vessel 20A and 20C, nitrate anions pass through the membrane 25 from the retentate chamber 26 to the permeate chamber 27, while uranyl cations are retained in the retentate chamber. Concentrate feed 201 enters retentate chamber 26 of membrane vessel 20A with a ratio of nitrate anions to uranyl cations of about 1.85:1 to 2:1. Concentrate feed 201 exits retentate chamber 26 of membrane vessel 20A with a reduced ratio of nitrate anions to uranyl cations of <1.85:1, <1.82:1, or <1.8:1. The concentrate feed 201 exits retentate chamber 26 of membrane vessel 20C as a retentate stream 204 with a further reduced target ratio of nitrate anions to uranyl cations of <1.75:1, or <1.7:1.

In some embodiments, two membrane vessels 20A and 20C may not be adequate to produce the desired target ratio of nitrate anions to uranyl cations. Again referring to FIG. 3C, a third membrane vessel 20B, including an anion exchange membrane 25 separating a retentate chamber 26 from a permeate chamber 27, may be positioned between vessels 20A and 20C. Concentrate stream 201 flows sequentially through the retentate chamber 26 of membrane vessels 20A, 20B, and 20C. Distillate feed 202 flows sequentially through the permeate chambers 27 of membrane vessel 20C, 20B, and 20A, in a countercurrent direction to the concentrate feed. In each membrane vessel 20A, 20B, and 20C, nitrate anions pass through the membrane 25 from the retentate chamber 26 to the permeate chamber 27, so that the ratio of nitrate anions to uranyl cations is reduced in a stepwise fashion as the concentrate stream 201 flows through membrane vessels 20A, 20B, and 20C.

In some embodiments, four, five, or more membrane vessels may be required to produce a retentate stream 204 with the desired target ratio of nitrate anions to uranyl cations. Again referring to FIG. 3C, membrane vessel 20n, including an anion exchange membrane 25 separating a retentate chamber 26 from a permeate chamber 27, may be positioned between vessels 20B and 20C. Membrane vessel 20n may be a single membrane vessel, or membrane vessel 20n may include two, three, or more membrane vessels connected in series between vessels 20B and 20C. Concentrate stream 201 flows sequentially through the retentate chamber 26 of membrane vessels 20A, 20B, 20n, and 20C. Distillate feed 202 flows sequentially through the permeate chambers 27 of membrane vessel 20C, 20n, 20B, and 20A, in a countercurrent direction to the concentrate feed. Membrane vessel 20n may include any number of membrane vessels adequate to produce a retentate stream 204 with the desired target ratio of nitrate anions to uranyl cations. In various embodiments, concentrate stream 201 enters the retentate chamber 26 of membrane vessels 20A with a target ratio of nitrate anions to uranyl cations of >1.85:1, and retentate stream 204 exits membrane vessel 20C with a target ratio of nitrate anions to uranyl cations of <1.7:1.

Referring to FIG. 4, the retentate stream 204 from FIG. 3A is fed to a vacuum distillation system to concentrate the retentate solution. The vacuum distillation system includes an inlet for a feed solution 303, comprising the solution from retentate stream 204. Feed solution 303 flows through a check valve 36 that prevents feed solution 303 from backflowing and returning to a membrane vessel 20C, shown in FIGS. 3A and 3C. An actuated valve 37 is controlled by a level sensor 38. Level sensor 38 is configured to send a signal to a processor (not shown). Upon receipt of the signal from the processor, the processor closes valve 37 fully or partially. Sensor 38 is connected to a packed column 32.

Feed solution 303 flows into a boiler or heat exchanger 31 from valve 37. Boiler or heat exchanger 31 may be a shell and tube heat exchanger or a column with an immersion heater, and function in a similar fashion to boiler 3 of FIG. 2. In the case where the boiler is a shell and tube heat exchanger, the boiler contains a bundle of tubes running through a hollow shell. In some embodiments, the feed solution 303 flows through the hollow shell in boiler 3 around the tubes, and a hot fluid 305 fluid flows into the tubes, at a temperature sufficient to boil the feed solution 303. As hot fluid 303 flows through the tubes, it transfers heat from hot fluid 305 to the feed solution 303 and boils the feed solution. As feed solution 303 is heated and boiled, hot fluid 103 is cooled and leaves the tubes in the boiler or heat exchanger 31 as a cooled heat exchange fluid 306.

Boiler 31 is part of a vacuum distillation system, where vacuum pump 33 reduces the pressure in boiler 31. connected to a vacuum pump As feed solution 303 boils under vacuum in boiler 31, the water in feed solution 303 is converted to a vapor. The vapor rises out of boiler 31 and into a packed column 32, where the vapor condenses under reflux. Vapor may be drawn off from column 32 with vacuum pump 33. The packed column 32 is filled with a packing material such as Raschig rings or wire mesh that allows for more vapor/liquid contact. When a level of condensed vapor in the packed column 32 reaches the level of the sensor 38, sensor 38 sends the signal to the processor. Upon receipt of the signal from the processor, the processor may fully or partially close valve 37, limiting further feed solution 303 from entering boiler 31 until an adequate amount of vapor is drawn off through pump 33.

Vapor from column 32 is drawn off by vacuum pump 33. The vapor then passes through a heater 34 that ensures the vapor remains hot enough to avoid condensation in a ventilation system. Finally, the heated vapor is discharged to process ventilation system 307, where it can enter the atmosphere as clean water vapor.

As vapor is drawn off from column 32, the feed solution 303 in heat exchanger 31 becomes increasingly concentrated. The feed solution 303 included NO₃ anions and UO₂ cations in a ratio of 1:1 to 1.8:1, 1.25:1 to 1.8:1, 1.4:1 to 1.8:1, 1.5:1 to 1.75:1, or 1.6:1 to 1.75 to 1. In heat exchange 31, the feed solution 303 is concentrated until a desired density is reached, at which time the concentrated feed solution is pumped from boiler 31 by pump 35 to produce a concentrated acid deficient uranyl nitrate (ADUN) stream 304. ADUN stream 304 includes:
NO₃ anions and UO₂ cations in a ratio of 1:1 to 1.8:1, 1.25:1 to 1.8:1, 1.4:1 to 1.8:1, 1.5:1 to 1.75:1, or 1.6:1 to 1.7 to 1;
a uranium concentration of 0.5 M to 4M, 0.5 M to 3.5 M, 1.5 M to 3.5 M, 2.5 M to 3.5 M, 2.5 M to 3.0 M, or 2.80 M to 3.27 M;
a nitrate concentration of 2 M to 7.8 M, 2.5 M to 6.5 M, 3M to 6 M, 4 M to 5.5 M, or 4.5 M to 5.25 M, and
a density of 1.85 g/cc to 2.00 g/cc.

In various embodiments, ADUN stream 304 produced by the method disclosed herein may have:
a NO3:U ratio of 1.5 to 1.7; a uranium concentration of from 0.5 M to 3.5 M; and a pH of 0.8 to 2.8; or
a NO3:U ratio of 1.5 to 1.7; a uranium concentration of from 2.5 M to 3.0 M; and a pH of 1.2 to 1.8.

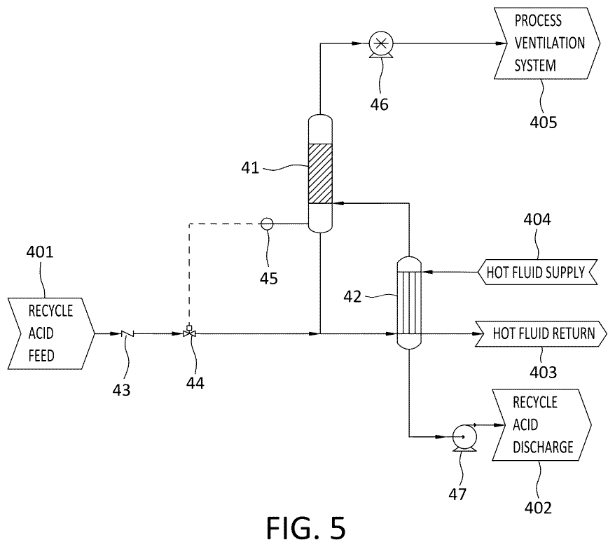

Referring to FIG. 5, the permeate stream 203 from FIG. 3A is fed to a vacuum distillation system for further processing. The vacuum distillation system includes an inlet for a feed solution 401, comprising the permeate stream 203. Feed solution 401 flows through a check valve 43 that prevents feed solution 401 from backflowing and returning to a membrane vessel 20A, shown in FIGS. 3A and 3C. An actuated valve 44 is controlled by a level sensor 45. Level sensor 45 is configured to send a signal to a processor (not shown). Upon receipt of the signal from the processor, the processor closes valve 44 fully or partially. Sensor 45 is connected to a packed column 41.

Feed solution 401 flows into a boiler or heat exchanger 42 from valve 44, which may be a shell and tube heat exchanger or a column with an immersion heater. In the case where the boiler 42 is a shell and tube heat exchanger, the feed solution 401 flows through the hollow shell in boiler 42 around a set of tubes tubes, and a hot fluid 404 flows into the tubes, at a temperature sufficient to boil the feed solution 401. As hot fluid 404 flows through the tubes, it transfers heat from hot fluid 404 to the feed solution 401 and boils the feed solution. As feed solution 401 is heated and boiled, hot fluid 404 is cooled and leaves the tubes in the boiler or heat exchanger 31 as a cooled heat exchange fluid 403.

Boiler 42 is part of a vacuum distillation system, where vacuum pump 46 reduces the pressure in boiler 42. As feed solution 401 boils under vacuum in boiler 42, the water in feed solution 404 is converted to a vapor. The vapor rises out of boiler 42 and into a packed column 41, where the vapor condenses under reflux. Vapor may be drawn off from column 41 with vacuum pump 46. When a level of condensed vapor in the packed column 46 reaches the level of the sensor 45, sensor 45 sends the signal to the processor. Upon receipt of the signal from the processor, the processor may fully or partially close valve 44, limiting further feed solution 401 from entering boiler 42.

Vapor from column 41 is drawn off by vacuum pump 46. The vapor is discharged to process ventilation system 405, where it can enter the atmosphere as clean water vapor.

Liquid from heat exchanger 42 may be pumped from heat exchanger 42 by pump 47 as a recycle acid discharge 402. Recycle acid discharge 402 is an acidic aqueous stream that may be used for fabrication of nuclear fuel, e.g., uranium oxide gel particles, by known processes.

In various embodiments, the process ventilation systems 108, 307, and 405, shown in FIGS. 2, 4, and 5, respectively, may be a single common process ventilation system. Alternatively, process ventilation systems 108, 307, and 405 may be different systems, isolated from each other.

Although the various embodiments disclosed herein have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A method of producing acid-deficient uranyl nitrate using an ion exchange membrane vessel having a first chamber, a second chamber, and an ion exchange membrane therebetween;
wherein the ion exchange membrane allows diffusion of NO₃ anions therethrough, but does not allow diffusion of UO₂ cations therethrough;
wherein the method comprises:
feeding a concentrated solution of uranyl nitrate to the first chamber of the ion exchange membrane vessel, wherein the concentrated solution includes NO₃ anions and UO₂ cations in a ratio of at least 1.85:1;
feeding an aqueous feed solution with a low concentration of NO₃ anions to the second chamber of the ion exchange membrane vessel;
allowing NO₃ anions to diffuse through the ion exchange membrane from the first chamber of the ion exchange membrane vessel to the second chamber;
withdrawing a retentate solution of uranyl nitrate from the first chamber of the ion exchange membrane vessel, wherein the retentate solution includes NO₃ anions and UO₂ cations in a ratio of 1:1 to 1.8:1;
withdrawing a permeate solution from the second chamber of the ion exchange membrane vessel, wherein the permeate solution includes an increased concentration of NO₃ anions, relative to the aqueous feed solution; and
feeding the retentate solution of uranyl nitrate to a vacuum distillation system to produce a concentrated solution of acid-deficient uranyl nitrate.

2. The method of claim 1, wherein the ion exchange membrane is an anion exchange membrane.

3. The method of claim 2, wherein the ion exchange membrane comprises a positively charged polymer.

4. The method of claim 1, wherein the retentate solution includes NO₃ anions and UO₂ cations in a ratio of 1.25:1 to 1.8:1.

5. The method of claim 4, wherein the concentrated solution of acid-deficient uranyl nitrate includes NO₃ anions and UO₂ cations in a ratio of 1.5:1 to 1.7:1, a uranium concentration of 2.80 M to 3.27 M, a nitrate concentration of 4.5 M to 5.25 M, and a density of 1.85 g/cc to 2.00 g/cc.

6. The method of claim 5, wherein the retentate solution includes NO₃ anions and UO₂ cations in a ratio of 1.5:1 to 1.7:1.

7. The method of claim 1, further comprising a step of feeding the concentrated solution of uranyl nitrate to a concentrate reservoir,
wherein the step of feeding the concentrated solution of uranyl nitrate to the first chamber comprises feeding the concentrated solution of uranyl nitrate from the concentrate reservoir to the first chamber.

8. The method of claim 1, wherein:
the concentrated solution of uranyl nitrate is fed to the first chamber of the ion exchange membrane vessel in a first direction; and
the aqueous feed solution is fed to the second chamber of the ion exchange membrane vessel in a second direction which is countercurrent to the first direction.

9. The method of claim 1, wherein:
the ion exchange membrane vessel comprises a first ion exchange membrane vessel, a second ion exchange membrane vessel, and optionally at least one third ion exchange membrane vessel;
feeding the concentrated solution of uranyl nitrate to the first chamber comprises sequentially feeding the concentrated solution of uranyl nitrate to a first chamber of the first ion exchange membrane vessel, a first chamber of the optional at least one third ion exchange membrane vessel, and a first chamber of the second ion exchange membrane vessel; and
feeding the aqueous feed solution to the second chamber comprises sequentially feeding the aqueous feed solution to a second chamber of the first ion exchange membrane vessel, a second chamber of the optional at least one third ion exchange membrane vessel, and a second chamber of the second ion exchange membrane vessel.

10. The method of claim 1, wherein:
the ion exchange membrane vessel comprises a first ion exchange membrane vessel and a second ion exchange membrane vessel;
feeding the concentrated solution of uranyl nitrate to the first chamber comprises feeding the concentrated solution of uranyl nitrate to a first chamber of the first ion exchange membrane vessel and a first chamber of the second ion exchange membrane vessel in parallel; and
feeding the aqueous feed solution to the second chamber comprises feeding the aqueous feed solution to a second chamber of the first ion exchange membrane vessel and a second chamber of the second ion exchange membrane vessel in parallel.

11. The method of claim 1, wherein the ion exchange membrane comprises:
a polystyrene polymer or copolymer with quaternized aminostyrene repeat units; or
a (meth)acrylic polymer or copolymer with quaternized aminoalkyl (meth)acrylate repeat units.

12. The method of claim 1, further comprising a step of feeding a dilute solution of uranyl nitrate to an evaporator and evaporating water from the dilute solution of uranyl nitrate to produce the concentrated uranyl nitrate solution and a vapor containing water with only trace amounts of nitric acid and uranyl nitrate.

13. The method of claim 12, further comprising a step of feeding the concentrated uranyl nitrate solution to a concentrate reservoir, and feeding the concentrated uranyl nitrate solution from the concentrate reservoir to the first chamber of the ion exchange membrane vessel.

14. The method of claim 12, further comprising a step of condensing the vapor to produce an aqueous condensate, and using the aqueous condensate as the aqueous feed solution.

15. A system for producing acid-deficient uranyl nitrate, comprising:
an ion exchange membrane vessel having a first chamber, a second chamber, and an ion exchange membrane therebetween, wherein:
the first chamber of the ion exchange membrane vessel is configured to receive a concentrated solution of uranyl nitrate;
the second chamber of the ion exchange membrane vessel is configured to receive an aqueous feed solution with a low concentration of NO₃ anions; and
the ion exchange membrane is configured to allow diffusion of NO₃ anions therethrough, but does not allow diffusion of UO₂ cations therethrough;
a first vacuum distillation system configured to receive a retentate solution from the first chamber of the ion exchange membrane vessel and produce a concentrated solution of acid-deficient uranyl nitrate.

16. The system of claim 15, wherein:
the ion exchange membrane comprises:
a polystyrene polymer or copolymer with quaternized aminostyrene repeat units; or
a (meth)acrylic polymer or copolymer with quaternized aminoalkyl (meth)acrylate repeat units.

17. The system of claim 15, further comprising:
a concentrate reservoir, wherein the concentrate reservoir is configured to store the concentrated solution of uranyl nitrate; and
a first system configured to feed the concentrated solution of uranyl nitrate from the concentrate reservoir to the first chamber of the ion exchange membrane vessel.

18. The system of claim 17, further comprising:
a second distillation system configured to receive a dilute uranyl nitrate solution and produce the concentrated solution of uranyl nitrate; and
a second system configured to feed the concentrated solution of uranyl nitrate to the concentrate reservoir.

19. A method of producing acid-deficient uranyl nitrate using the system of claim 14, comprising;
feeding the concentrated solution of uranyl nitrate to the first chamber of the ion exchange membrane vessel;
feeding the aqueous feed solution with a low concentration of NO₃ anions to the second chamber of the ion exchange membrane vessel;
allowing diffusion of NO₃ anions through the ion exchange membrane; and
feeding a retentate solution from the first chamber of the ion exchange membrane vessel to the first vacuum distillation system to produce a concentrated solution of acid-deficient uranyl nitrate.
